(19) United States
(12) Patent Application Publication
(10) Pub. No.: US 2007/0059068 A1
(43) Pub. Date: Mar. 15, 2007

(54) Automatic document handler guidance graphic

(75) Inventor: Alan D. Winter, Luton (GB)

Correspondence Address: FAY SHARPE LLP, 1100 SUPERIOR AVENUE, SEVENTH FLOOR, CLEVELAND, OH, 44114, US

(73) Assignee: XEROX CORPORATION

(21) Appl. No.: 11/225,778

(22) Filed: Sep. 13, 2005

(51) Int. Cl. G03G 15/00

(52) U.S. Cl. 399/367

(57) ABSTRACT

A document handler (10) including a document receptacle (12) receiving document sheets for processing, and a user guidance graphic (50, 150, 250) disposed on the document receptacle (12). The user guidance graphic (50, 150, 250) includes at least one guidance graphic element (51, 52, 53, 54, 151, 152, 153, 154, 251, 252, 253, 254) having no even rotational symmetry and visually distinguishable up and down directions aligned on the document receptacle (12) with correct up and down directions for loading document sheets on the document receptacle (12).

### BACKGROUND

The following relates to the sheet processing arts. It particularly relates to duplex printing with binding for producing booklets, stapled packets, or other bound copies, and is described with particular reference thereto. The following relates more generally to document sheet processing for general printing, optical scanning, facsimile transmission, and so forth.

Existing printing systems typically make copies of document sheets that are loaded into an automatic document handler. Existing printers provide simplex (single-sided) and optionally also duplex (double-sided) printing, and may include sheet handling hardware for rotating, flipping, or otherwise physically manipulating sheets of paper or other print media. Accordingly, the orientation of the output copies in the destination tray may have no obvious relationship with the orientation in which the document sheets were loaded in the automatic document handler.

Existing printing systems typically also provide finishing capabilities such as binding, hole-punching, or so forth. Some of these finishing capabilities are document sheet orientation-dependent. For example, when binding duplex copies as a booklet, the binding edge should be correctly oriented respective to the text, images, or other markings produced by the duplex printing.

Paper, transparencies, and other print media sheets come in various sizes, such as letter, A4, legal, and so forth. The text on document sheets can be oriented as landscape or portrait. In the portrait orientation, the short edges of the paper are at top and bottom, while the long edges of the paper are at the left and right sides. In the landscape orientation, the long edges of the paper are at top and bottom, while the short edges of the paper are at the left and right sides.

Some existing automatic document handlers automatically determine the sheet size of a document, and whether the document sheets are being fed by a short or long edge of the sheet. These automatic determinations are suitably made using optical or tactile sensors, detecting positions of manually set paper guides, measuring paper feed distance, or so forth. Alternatively or additionally, the user may input the paper size and feed (short or long side) using selection buttons, a touch-sensitive interface LCD display, or so forth. Thus, existing automatic document handlers provide approaches for addressing sheet size and short or long feed.

However, ambiguity still exists even for a given document sheet size and a given long or short feed. Rectangular sheets have physical two-fold rotational symmetry that is addressed by determining sheet size and feed. However, document sheets additionally include text, graphics, or other markings that typically have no rotational symmetry. Accordingly, document sheets can be loaded into the automatic document handler upside-down, that is, rotated 180° away from the proper orientation. Automatic sensors that determine sheet size and long or short feed do not detect such upside down loading. Incorrect upside-down loading can be problematic if the applied finishing, such as binding, stapling, or so forth, is orientation-dependent. For example, a bound booklet may come out bound on the wrong side, or a stapled set of sheets may be stapled in the wrong corner.

Existing techniques for ensuring that the user correctly loads the originals right-side up have deficiencies. In some approaches, the LCD display or other display informs the user of the proper loading orientation. However, such document loading instructions can be ambiguous and susceptible to misinterpretation. For example, instructing the user via the LCD display to load the originals in a “landscape orientation” does not unambiguously specify loading with either the long edge or short edge in. Instructing the user to load the document with a “long edge feed” may also be unclear to the user if the user is unfamiliar with that term. The LCD display is typically located away from the automatic document hander, for example on a main console of the printing system. As a result, the user may fail to notice the loading instructions on the remote display when loading a document into the automatic document handler, or may fail to recognize that those instructions pertain to the proper loading of the document sheets in the automatic document handler.

### BRIEF DESCRIPTION

According to aspects illustrated herein, there is provided a document handler including a document receptacle receiving document sheets for processing, and a plurality of user guidance graphic elements disposed on the document receptacle. The plurality of user guidance graphic elements corresponds to a plurality of document loadings supported by the document handler. Each user guidance graphic element includes: (i) a sheet representation indicating a correct orientation of long and short edges of the document sheet for the corresponding loading; and (ii) a symbol or image disposed in the sheet representation and having visually distinguishable up and down directions indicating correct up and down directions of the document sheet for the corresponding loading.

According to aspects illustrated herein, there is provided a document handler including a document receptacle receiving document sheets for processing, and a user guidance graphic disposed on the document receptacle. The user guidance graphic includes at least one guidance graphic element having no even rotational symmetry and visually distinguishable up and down directions aligned on the document receptacle with correct up and down-directions for loading document sheets on the document receptacle.

According to aspects illustrated herein, there is provided an electrostatographic system. At least one electrostatographic-marking engine generates electrostatographically marked sheets corresponding to document sheets loaded on a document receptacle. A finisher binds the electrostatographically marked sheets. A user guidance graphic element is disposed on the document receptacle. The user guidance graphic element has visually distinguishable up and down directions aligned on the document receptacle with correct up and down directions for loading the document sheets on the document receptacle such that the electrostatographically marked sheets are bound in a correct orientation by the finisher.

### BRIEF DESCRIPTION OF THE DRAWINGS

FIG. 1 diagrammatically illustrates a perspective view of a printing system that includes an automatic document handler with a user guidance graphic disposed thereon.

FIG. 2 shows an overhead view of a portion of the automatic document handler of the printing system of FIG. 1 including the user guidance graphic.

FIG. 3 diagrammatically shows how the user guidance graphic aids the user in correctly loading portrait originals for long-edge feed.

FIG. 4 shows an overhead view of the document handler of FIG. 2 with portrait originals correctly loaded for long-edge feed.

FIG. 5 diagrammatically shows how the user guidance graphic aids the user in correctly loading portrait originals for short-edge feed.

FIG. 6 shows an overhead view of the document handler of FIG. 2 with portrait originals correctly loaded for short-edge feed.

FIG. 7 shows another embodiment of the user guidance graphic, which uses text to indicate correct up and down directions for loading document sheets.

FIG. 8 shows another embodiment of the user guidance graphic, which uses a bilaterally symmetric image to indicate correct up and down directions for loading document sheets.

### DETAILED DESCRIPTION

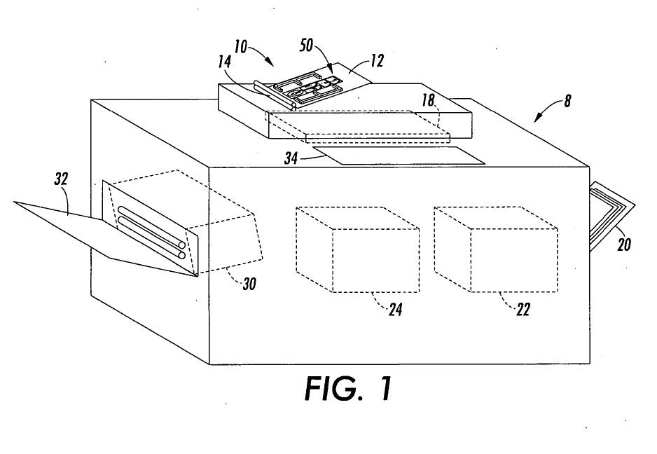

With reference to FIG. 1, a printing system 8 includes a document handler 10 for loading a document for copying. The document handler 10 includes a document receptacle 12, such as a tray, plate, sleeve, platen, or so forth on which document sheets are loaded, and a sheet handler, such as rollers 14, for selectively moving document sheets from the document receptacle 12 for printing. An imager 18 (shown diagrammatically in phantom) acquires an image of each document sheet acquired by the sheet handler 14. The imager 18 can directly acquire an analog image such as an electrostatic image, or the imager 18 can digitize the original to acquire a temporarily or permanently stored digital image. Optionally, the document handler 10 is a duplex automatic document handler (DADH) that can manipulate document sheets to enable the imager 18 to acquire images of both front and back sides, enabling duplex reproduction. Additionally or alternatively, multiple imagers can be provided to acquire front and back sides of the document sheet for duplex processing.

A print media source 20 supplies blank sheets of paper, blank transparencies, letterhead paper, or other print media sheets to the printing system 8. At least one marking engine 22, 24 (shown diagrammatically in phantom) forms a representation of the image acquired by the imager 18 on sheets of the print medium. In simplex printing, the print medium sheet is marked on only one side; in duplex printing, the print medium sheet is marked on both sides. In some embodiments, the at least one marking engine 22, 24 includes at least one electrostatographic marking engine that generates electrostatographically marked sheets corresponding to the document sheets. For example, at least one electrostatographic marking engine may produce electrostatographic copies of the document sheets based on an electrostatic image of the document sheet directly acquired by the imager 18, or based on an electrostatic image generated from a stored image of the document sheet acquired by the imager 18. For color printing, more than one marking engine 22, 24 is suitably employed. For example, marking engines for cyan (“C”), magenta (“M”), yellow (“Y”), and black (“K”) can be used to perform CMYK color printing. For duplex printing, paper handling hardware (not shown) is typically provided to flip or otherwise manipulate the print medium sheet to enable marking on both front and back sides of the print medium sheet. Alternatively or additionally, separate marking engines can be provided for printing on the front and back sides of the sheet. In some embodiments, each marking engine includes its own print media source.

A finisher 30 (shown diagrammatically in phantom) optionally performs finishing tasks such as binding the marked print media sheets to form a booklet, stapled packet of sheets, or so forth, hole-punching the marked print media sheets, or so forth. The finished product is disposed in an output destination 32. Some printing systems may provide more than one paper source, and/or more than one output destination. The printing system 8 optionally provides a large number of options, such as simplex printing, duplex printing, edge binding, stapling, hole-punching, capability of processing sheets of various sheet sizes, capability of processing either short edge feed or long edge feed sheets, and so forth. A processor (not shown) and a user interface, such as a touch-sensitive LCD display 34, are optionally provided to control the printing system 8 and to enable the user to select from amongst the provided options.

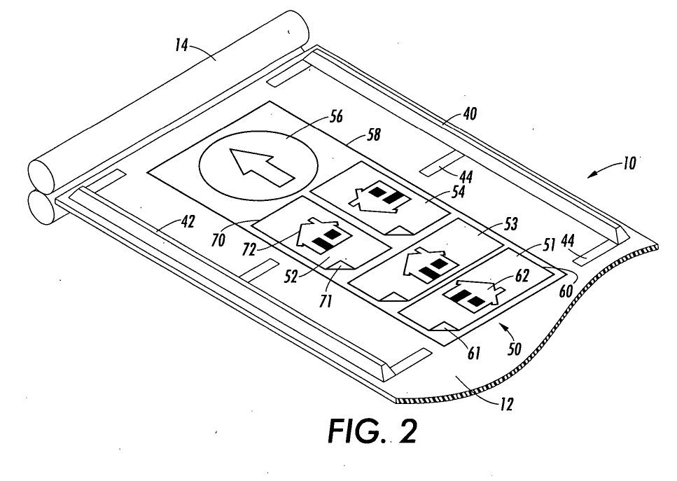

With continuing reference to FIG. 1 and further reference to FIG. 2, operations performed by the finisher 30 can be sheet orientation-dependent. To ensure proper finishing, the document sheets should be loaded into the document handler 10 properly. Rectangular document sheets can be loaded for short-edge feeding, in which a short edge of the document sheet is closest to the sheet handler rollers 14, or rectangular document sheets can be loaded for long-edge feeding, in which a long edge of the document sheet is closest to the sheet handler rollers 14. In some contemplated embodiments, the document handler may support only one edge feed mode, such as only short edge feed or only long edge feed. Moreover, the document sheets can be either portrait or landscape. In the portrait orientation, the short edges of the sheet are at top and bottom, while the long edges of the sheet are at the left and right sides. In the landscape orientation, the long edges of the sheet are at top and bottom, while the short edges of the sheet are at the left and right sides.

Sheet guides 40, 42 are used to position the document sheets on the document receptacle 12. In the illustrated embodiment, the sheet guides 40, 42 are slidable on tracks 44 to manually set the separation of the sheet guides 40, 42 to the paper size and edge feed (short or long). For example, when short edge feeding is used, the sheet guides 40, 42 are moved relatively closer together than when long edge feeding is used. Other arrangements can be used for physically positioning sheets on the document receptacle 10. For example, one sheet guide can be stationary and the other movable, or, if only one sheet size and edge feed mode is available, two stationary sheet guides can be used.

In some embodiments, the sheet size and edge feed are determined automatically when the document is loaded on the document receptacle 12, for example based on the position of the sheet guides 40, 42, based on information provided by optical sensors built into the document handler 10, based on a sheet feeding distance required for the sheet handler 14 to draw a sheet off of the document receptacle 12, based on sheet dimension and orientation measurements performed using the imager 18, or so forth. In other embodiments, the user enters the selected sheet size and selected edge feed using the touch-sensitive LCD display 34. In the latter case, sheet guide positions, sensors, or so forth are optionally used to verify that the user loaded a document of the selected sheet size for the selected edge feed.

Additionally, the document should be placed in the correct up/down orientation to ensure that the finishing is performed properly. That is, the document sheets should not be loaded upside down, that is, with a 180° rotation. Proper up/down orientation enables the finisher 30 to, for example, bind the proper sheet edges to form a booklet. Compared with sheet size and edge feed, it is typically more difficult to automatically determine or verify the up/down orientation of loaded documents sheets. This is because the correct up/down orientation is determined by the markings on the sheet, rather than by physical dimensions of the sheet. Document sheets can be loaded upside-down or having a 180° rotation, while still having the correct physical dimensions and the correct long or short edge feed.

Accordingly, a user guidance graphic 50 is disposed on the document receptacle 12 of the automatic document handler 10, for example as a relief formed into a surface of the document receptacle 12, as a label adhered to a surface of the document receptacle 12, as ink disposed on a surface of the document receptacle 12, or so forth. The user guidance graphic 50 includes one or more guidance graphic elements 51, 52, 53, 54 corresponding to different supported loadings of document sheets. Each of the guidance graphic elements 51, 52, 53, 54 has visually distinguishable up and down directions aligned on the document receptacle with correct up and down directions for loading document sheets of the corresponding loading on the document receptacle 12. By placing the guidance graphic 50 directly on the document receptacle 12, it is likely that the user will see the guidance graphic 50 and will recognize that the guidance graphic 50 is providing guidance for loading the document sheets on the document receptacle 12.

The illustrated guidance graphic 50 includes the four guidance graphic elements 51, 52, 53, 54 corresponding to four different loadings of document sheets supported by the document handler 10. The guidance graphic 51 provides guidance for loading portrait document sheets for long edge feeding. The guidance graphic 52 provides guidance for loading portrait document sheets for short edge feeding. The guidance graphic 53 provides guidance for loading landscape document sheets for long edge feeding. The guidance graphic 54 provides guidance for loading landscape document sheets for short edge feeding. It will be appreciated that the number of guidance graphic elements depends upon the number of supported loadings. For example, if the document handler only supports short edge feeding, then the guidance graphic elements 51, 53 which pertain to unsupported long edge feedings are suitably omitted. The user guidance graphic 50 optionally includes other elements or features, such as the illustrated arrow element 56 that guides the user to position the document sheets against the rollers 14, and the surrounding rectangular border 58 that indicates boundaries of the user guidance graphic 50.

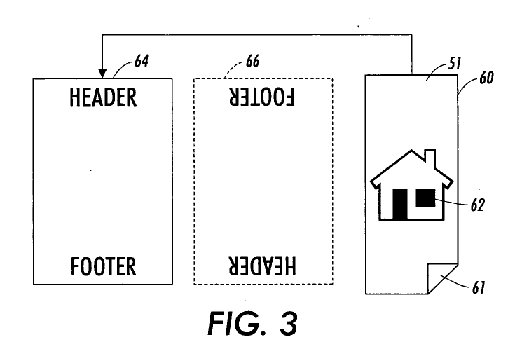

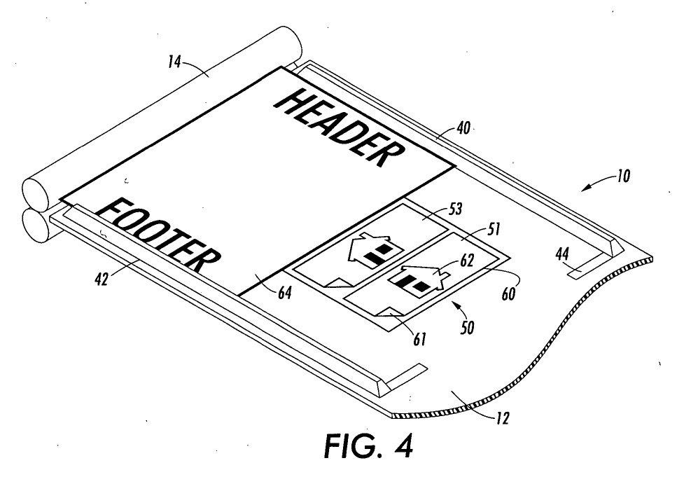

With continuing reference to FIG. 2 and with further reference to FIGS. 3 and 4, an example is provided of using the guidance graphic element 51 for guiding the loading of portrait document sheets for long-edge feeding. The guidance graphic element 51 includes a generally rectangular sheet representation 60 aligned on the document receptacle 12 to indicate long edge document feed. In the illustrated embodiment, the generally rectangular sheet representation 60 includes an upturned sheet corner representation 61 that helps ensure that the user recognizes that a sheet is being depicted. The guidance graphic element 51 also includes an image 62 inside the generally rectangular sheet representation 60. The image 62 has visually distinguishable up and down directions aligned on the document receptacle 12 with correct up and down directions for loading portrait document sheets in the long edge feed position. The example image 62 depicts a house that has no rotational symmetry. As best seen in FIG. 3, the user recognizes the proper document sheet placement 64 in which the header and footer are correctly positioned based on the visually distinguishable up and down directions of the image 62. The user recognizes that the document sheets should not be loaded in the other possible long edge feed placement 66 (indicated in phantom in FIG. 3) in which the header and footer of the document sheets are upside-down, or in other words where the document sheet is rotated 180° away from the proper placement. FIG. 4 shows the portrait document sheet placement 64 properly loaded for long edge feeding based on the graphic element 51.

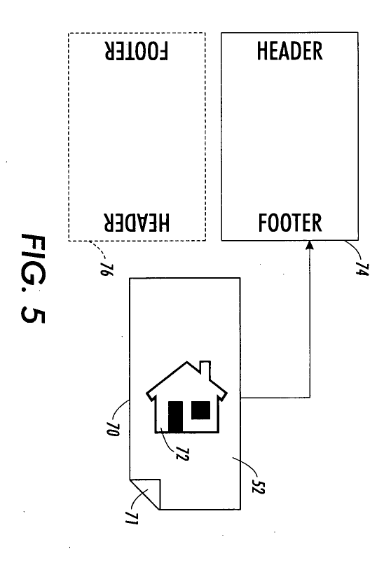

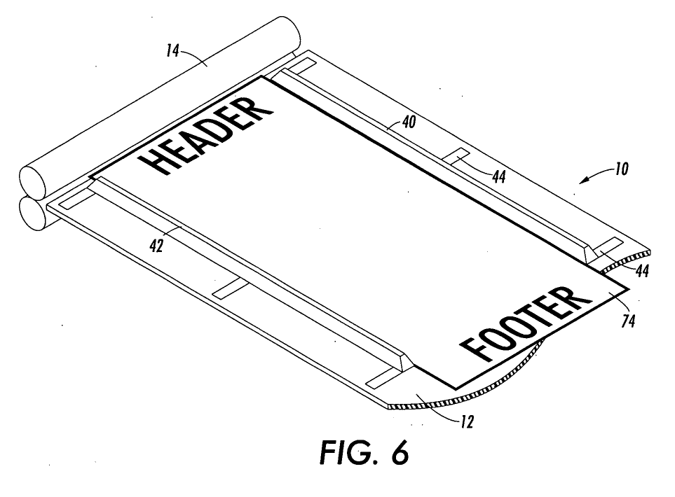

With continuing reference to FIG. 2 and with further reference to FIGS. 5 and 6, another example application is illustrated, this time using the guidance graphic element 52 for guiding the user in loading portrait document sheets for short-edge feeding. The guidance graphic element 52 includes a generally rectangular sheet representation 70 aligned on the document receptacle 12 to indicate long edge document feed. In the illustrated embodiment, the generally rectangular sheet representation 70 includes an upturned sheet corner representation 71 that helps ensure that the user recognizes that a sheet is being depicted. The guidance graphic element 52 also includes an image 72 inside the generally rectangular sheet representation 70. The image 72 has visually distinguishable up and down directions aligned on the document receptacle 12 with correct up and down directions for loading portrait document sheets in the short edge feed position. The example image 72 depicts a house that has no rotational symmetry. As best seen in FIG. 5, the user recognizes the proper document sheet placement 74 in which the header and footer are correctly positioned based on the visually distinguishable up and down directions of the image 72. The user recognizes that the document sheets should not be loaded in the other possible short edge feed placement 76 (indicated in phantom in FIG. 5) in which the header and footer of the document sheets are upside-down, or in other words where the document sheet is rotated 180° away from the proper placement. FIG. 6 shows the portrait document sheet placement 74 properly loaded for short edge feeding based on the graphic element 52.

Application of the remaining graphic elements 53, 54 is analogous to the described application of graphic elements 51, 52, except that the graphic elements 53, 54 are referenced by the user when loading landscape document sheets for long edge feeding or for short edge feeding, respectively.

Loaded long edge feed sheets cover a portion of the guidance graphic 50 including the graphic elements 52, 54, as seen in FIG. 4. Loaded short edge feed sheets cover the entire guidance graphic 50 including all four graphic elements 51, 52, 53, 54, as seen in FIG. 6. Accordingly, the user is likely to notice the guidance graphic 50 as the user loads the sheets, and is likely to recognize the guidance being provided by the graphic 50. In some other contemplated embodiments, the guidance graphic is disposed on the document receptacle at a location that is not covered partially or entirely by loaded document sheets, but which location is close enough to where the sheets are loaded to make it likely that the user will see the guidance graphic and recognize the document loading guidance being provided.

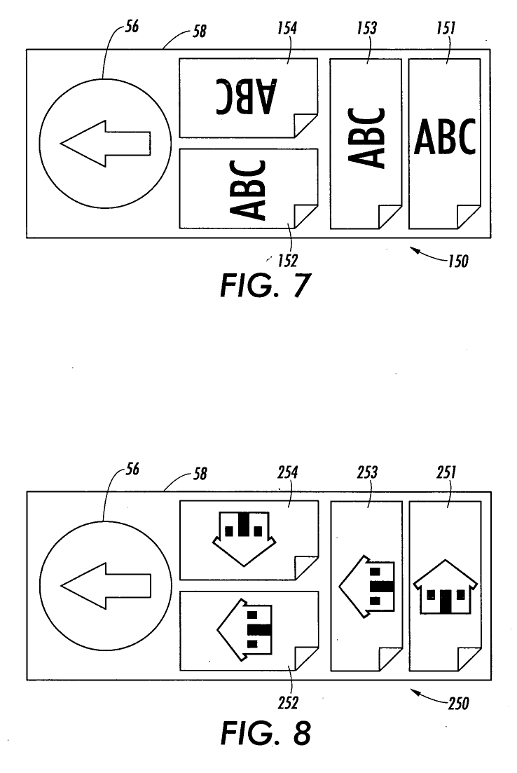

With reference to FIG. 7, a symbol or plurality of symbols, such as text, can be used in the graphic elements, instead of an image, for providing the visually distinguishable up and down directions aligned on the document receptacle 12 with correct up and down directions for loading document sheets. Thus, for example, in FIG. 7 a user guidance graphic 150 include graphic elements 151, 152, 153, 154 each using the text “ABC”, instead of an image of a house, to provide the visually distinguishable up and down directions. The guidance graphic 151 provides guidance for loading portrait document sheets for long edge feeding. The guidance graphic 152 provides guidance for loading portrait document sheets for short edge feeding. The guidance graphic 153 provides guidance for loading landscape document sheets for long edge feeding. The guidance graphic 154 provides guidance for loading landscape document sheets for short edge feeding. The user guidance graphic 150 suitably optionally replaces the user guidance graphic 50 on the document receptacle 12 shown in FIG. 2, for example. The text “ABC” used in the graphic elements 151, 152, 153, 154 employs the Latin alphabet. However, text in the Cyrillic, Arabic, or another alphabet or lettering system is also contemplated. In other contemplated embodiments, one or more symbols other than text can provide the visually distinguishable up and down directions. For example, one or more symbols can be used that are taken from a writing system such as Chinese or Japanese that is not letter-based.

With reference to FIG. 8, a symbol having bilateral symmetry can be used in the graphic elements for providing the visually distinguishable up and down directions aligned on the document receptacle 12 with correct up and down directions for loading document sheets. Thus, for example, in FIG. 8 a user guidance graphic 250 include graphic elements 251, 252, 253, 254 each using an image of a house having bilateral symmetry to provide the visually distinguishable up and down directions. The image of the house used in graphic elements 251, 252, 253, 254 does not have rotational symmetry. The guidance graphic 251 provides guidance for loading portrait document sheets for long edge feeding. The guidance graphic 252 provides guidance for loading portrait document sheets for short edge feeding. The guidance graphic 253 provides guidance for loading landscape document sheets for long edge feeding. The guidance graphic 254 provides guidance for loading landscape document sheets for short edge feeding. The user guidance graphic 250 suitably optionally replaces the user guidance graphic 50 on the document receptacle 12 shown in FIG. 2, for example.

Symbols or images that do not have even rotational symmetry (such as two-fold rotational symmetry, four-fold rotational symmetry, or so forth) are suitable for use as the symbol or image providing the visually distinguishable up and down directions. A symbol with even rotational symmetry, such as a “+” or “×” symbol, is not suitable because such a symbol does not visually distinguish up and down directions. For example, a plus sign (“+”) that is rotated 180° is indistinguishable from the unrotated plus sign. A symbol or image with only odd rotational symmetry (such as three-fold rotational symmetry, five-fold rotational symmetry, or so forth), such as an equilateral triangle or a pentagram, can be used as long as the user is likely to recognize visually distinguishable up and down directions.

The printing system 8 is an illustrative example. The automatic document handlers and automatic document handler guidance graphics disclosed herein can readily be adapted for use with substantially any type of printing system that calls for loading original documents with a particular up/down orientation. The printing system may be black-only, or two-tone providing a highlighting color, or modular, or so forth. The printing system may use electrostatic printing, ink jet printing, bubble jet printing, thermocompressive printing, combinations thereof, or other printing mechanisms.

Moreover, although described with reference to printing system applications, it will be appreciated that the automatic document handlers and automatic document handler guidance graphics disclosed herein are also suitable for use with other sheet processing systems, such as facsimile machines, optical scanners, and so forth. For example, in the case of an optical scanner, a document sheet that is loaded upside down will be scanned to produce a digital image that is upside down. Such a digital image can generally be corrected by a 180° rotation implemented in software. However, this process can be time-consuming, and a novice user may be unable to perform such image rotation. Accordingly, it is advantageous to dispose a user guidance graphic, such as one of the user guidance graphics 50, 150, 250 illustrated herein, on the automatic paper handler of the optical scanner to aid the user in correctly orienting the document in the first place, so that post scan rotational processing is avoided. In some embodiments, the sheet processing system is an integrated system providing, for example, printing, copying, facsimile transmission and/or receiving, and optical scanning capabilities in an integrated package. In such an integrated system, the automatic paper handler suitably has disposed thereon a user guidance graphic, such as one of the user guidance graphics 50, 150, 250 illustrated herein, to aid the user in correctly orienting documents for copying, optical scanning, or other processing which utilizes physical document sheets as input.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A document handler comprising:
a document receptacle receiving document sheets for processing; and
a plurality of user guidance graphic elements disposed on the document receptacle, the plurality of user guidance graphic elements corresponding to a plurality of document loadings supported by the document handler, each user guidance graphic element including: (i) a sheet representation indicating a correct orientation of long and short edges of the document sheet for the corresponding loading and (ii) a symbol or image disposed in the sheet representation and having visually distinguishable up and down directions indicating correct up and down directions of the document sheet for the corresponding loading.

2. The document handler as set forth in claim 1, wherein the plurality of user guidance graphic elements include elements for supported document loadings including a long-edge feed loading and a short-edge feed loading.

3. The document handler as set forth in claim 1, wherein the plurality of user guidance graphic elements include elements for supported document loadings including a portrait document loading and a landscape document loading.

4. The document handler as set forth in claim 1, wherein the plurality of user guidance graphic elements include elements for supported document loadings including a long-edge feed portrait document loading, a short-edge feed portrait document loading, a long-edge feed landscape document loading, and a short-edge feed landscape document loading.

5. The document handler as set forth in claim 1, wherein the plurality of user guidance graphic elements are disposed on the document receptacle such that loaded document sheets block at least one of the user guidance graphic elements from view.

6. The document handler as set forth in claim 1, wherein the user guidance graphic elements have no even rotational symmetry.

7. The document handler as set forth in claim 1, wherein the user guidance graphic elements have bilateral symmetry.

8. The document handler as set forth in claim 1, wherein the user guidance graphic elements have neither bilateral symmetry nor even rotational symmetry.

9. The document handler as set forth in claim 1, wherein the plurality of user guidance graphic elements are disposed on the document receptacle as at least one of:
a relief formed into a surface of the document receptacle,
a label adhered to a surface of the document receptacle, and
ink disposed on a surface of the document receptacle.

10. A document handler comprising:
a document receptacle receiving document sheets for processing; and
a user guidance graphic disposed on the document receptacle, the user guidance graphic including at least one guidance graphic element having no even rotational symmetry and visually distinguishable up and down directions aligned on the document receptacle with correct up and down directions for loading document sheets on the document receptacle.

11. The document handler as set forth in claim 10, wherein the user guidance graphic comprises:
a portrait user guidance graphic element having no even rotational symmetry and visually distinguishable up and down directions aligned on the document receptacle with correct up and down directions for loading portrait document sheets on the document receptacle; and
a landscape user guidance graphic element having no even rotational symmetry and visually distinguishable up and down directions aligned on the document receptacle with correct up and down directions for loading landscape document sheets on the document receptacle.

12. The document handler as set forth in claim 10, wherein the document handler is capable of supplying document sheets in either a long-edge feed orientation or a short-edge feed orientation, the user guidance graphic comprising:
a long-edge feed user guidance graphic element having no even rotational symmetry and visually distinguishable up and down directions aligned on the document receptacle with correct up and down directions for loading document sheets for long-edge feeding; and
a short-edge feed user guidance graphic element having no even rotational symmetry and visually distinguishable up and down directions aligned on the document receptacle with correct up and down directions for loading document sheets for short-edge-feeding.

13. The document handler as set forth in claim 10, wherein the document handler is capable of supplying document sheets in either a long-edge feed orientation or a short-edge feed orientation, the user guidance graphic comprising:
a long-edge-feed portrait user guidance graphic element having no even rotational symmetry and visually distinguishable up and down directions aligned on the document receptacle with correct up and down directions for loading portrait document sheets for long-edge feeding;
a short-edge-feed portrait user guidance graphic element having no even rotational symmetry and visually distinguishable up and down directions aligned on the document receptacle with correct up and down directions for loading portrait document sheets for short-edge-feeding;
a long-edge-feed landscape user guidance graphic element having visually distinguishable up and down directions aligned on the document receptacle with correct up and down directions for loading landscape document sheets for long-edge feeding; and
a short-edge-feed landscape user guidance graphic element having visually distinguishable up and down directions aligned on the document receptacle with correct up and down directions for loading landscape document sheets for short-edge-feeding.

14. The document handler as set forth in claim 10, wherein the at least one user guidance graphic element comprises:
a generally rectangular sheet representation aligned on the document receptacle to indicate one of a long edge document feed and a short edge document feed; and
an image or symbol having no even rotational symmetry and visually distinguishable up and down directions aligned on the document receptacle with correct up and down directions for loading document sheets in the long edge or short edge feed position indicated by the generally rectangular sheet representation.

15. The document handler as set forth in claim 14, wherein the image or symbol is selected from a group consisting of: (i) one or more letters and (ii) an image.

16. The document handler as set forth in claim 10, wherein the user guidance graphic is disposed on the document receptacle as at least one of:
a relief formed into a surface of the document receptacle,
a label adhered to a surface of the document receptacle, and
ink disposed on a surface of the document receptacle.

17. An electrostatographic system comprising:
a document receptacle;
at least one electrostatographic marking engine generating electrostatographically marked sheets corresponding to document sheets loaded on the document receptacle;
a finisher that binds the electrostatographically marked sheets; and
a user guidance graphic element disposed on the document receptacle, the user guidance graphic element having visually distinguishable up and down directions aligned on the document receptacle with correct up and down directions for loading the document sheets on the document receptacle such that the electrostatographically marked sheets are bound in a correct orientation by the finisher.

18. The electrostatographic system as set forth in claim 17, wherein the user guidance graphic element includes a plurality of user guidance graphic elements corresponding to a plurality of supported document sheet loadings.

19. The electrostatographic system as set forth in claim 18, wherein the plurality of user guidance graphic elements include elements for supported document loadings including at least two of:
a long-edge feed portrait document loading,
a short-edge feed portrait document loading,
a long-edge feed landscape document loading, and
a short-edge feed landscape document loading.

20. The electrostatographic system as set forth in claim 18, wherein the document receptacle is part of a duplex automatic document handler (DADH).

21. The electrostatographic system as set forth in claim 18, further comprising:
a touch-sensitive user interface for selecting one of the plurality of supported document sheet loadings, the touch-sensitive user interface displaying as selection indicators the plurality of user guidance graphic elements corresponding to the plurality of document sheet loadings.

22. The electrostatographic system as set forth in claim 17, wherein the user guidance graphic element comprises:
a sheet representation aligned on the document receptacle to indicate correct alignment of the long and short sheet edges of the document sheet; and
an image or symbol disposed in the sheet representation and having visually distinguishable up and down directions indicating correct up and down directions of the document sheet.
